(19) United States
(12) Patent Application Publication
(10) Pub. No.: US 2015/0222762 A1
(43) Pub. Date: Aug. 6, 2015

(54) SYSTEM AND METHOD FOR ACCESSING A CAMERA ACROSS PROCESSES

(71) Applicants: Wei Jia, San Jose, CA (US); Magnus Flodman, Tullinge (SE); Per Olov Gunnar Kjellander, Farsta (SE)

(72) Inventors: Wei Jia, San Jose, CA (US); Magnus Flodman, Tullinge (SE); Per Olov Gunnar Kjellander, Farsta (SE)

(73) Assignee: Google Inc., Mountain View, CA (US)

(21) Appl. No.: 13/439,783

(22) Filed: Apr. 4, 2012

(51) Int. Cl. H04N 5/232

(52) U.S. Cl. CPC H04N 1/00204; H04N 5/23206; H04N 5/23216

(57) ABSTRACT

A system and machine-implemented method for accessing a camera across processes on a device is provided. One or more requests for camera access is received from a corresponding one or more client modules. Camera capture parameters are determined based on the received one or more requests for camera access. A camera capture request specifying the determined parameters is provided to a camera device. At least one camera capture with the determined parameters is received from the camera device. The received at least one camera capture is provided to the one or more client modules.

### FIELD

The present disclosure generally relates to accessing a camera device, and, in particular, to accessing a camera device across multiple processes.

### BACKGROUND

In multi-process systems, certain processes may not have direct access to certain hardware and peripherals of the machine on which the process is being run. For example, an application (e.g., a web browser, video chat, video editing, etc.) process may not have direct access to a camera device and must proxy into another process to access the camera device. Often times, more than one process may need to access the camera device at the same time, either directly or by proxy.

### SUMMARY

The disclosed subject matter relates to a machine-implemented method for sharing a camera between processes on a device. One or more requests for camera access is received from a corresponding one or more client modules. Camera capture parameters are determined based on the received one or more requests for camera access. A camera capture request specifying the determined parameters is provided to a camera device. At least one camera capture with the determined parameters is received from the camera device. The received at least one camera capture is provided to the one or more client modules.

According to various aspects of the subject technology, a system comprising one or more processors and a machine-readable medium comprising instructions stored therein, which when executed by the processors, cause the processors to share a camera between processes on a device is provided. One or more requests for camera access is received from a corresponding one or more client modules. Camera capture parameters are determined based on the received one or more requests for camera access. A camera capture request specifying the determined parameters is provided to a camera device. At least one camera capture with the determined parameters is received from the camera device. The received at least one camera capture is resized to correspond to each of the several requests received from the corresponding several client modules. The resized at least one camera capture is provided to the one or more client modules.

The disclosed subject matter also relates to a machine-readable medium comprising instructions stored therein, which when executed by a system, cause the system to perform operations comprising receiving several requests for camera access from a corresponding several client modules. A resolution for at least one camera capture is determined based on the received one or more requests for camera access. A camera capture request specifying the determined resolution is provided to a camera device. At least one camera capture with the determined resolution is received from the camera device. The received at least one camera capture is resampled to correspond to each of the plurality of requests received from the corresponding plurality of client modules. The resampled at least one camera capture is provided to each of the plurality of client modules.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for accessing a camera across multiple processes operating on a client device.

FIG. 2 illustrates an example of a server system for accessing a camera across multiple processes operating on a client device.

FIG. 3 illustrates an example method for accessing a camera across multiple processes operating on a client device.

FIG. 4 provides an example graphical representation of accessing a camera across multiple processes operating on a client device.

FIG. 5 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter relates to a machine-implemented method for sharing a camera between processes on a device. One or more requests for camera access is received from a corresponding one or more client modules. Camera capture parameters are determined based on the received one or more requests for camera access. A camera capture request specifying the determined parameters is provided to a camera device. At least one camera capture with the determined parameters is received from the camera device. The received at least one camera capture is provided to the one or more client modules.

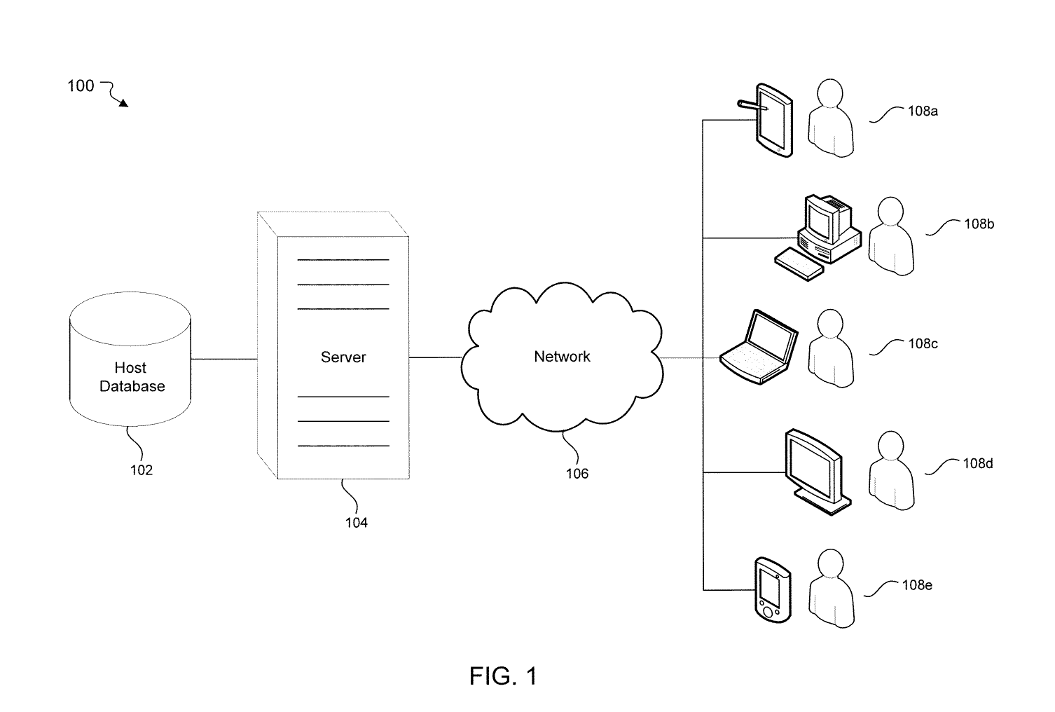

FIG. 1 illustrates an example network environment which provides for accessing a camera across multiple processes operating on a client device. Network environment 100 comprises one or more databases 102 (e.g., computer-readable storage devices) for storing a variety of data accessed by web-based applications. The network environment 100 further comprises one or more servers 104. Server 104 may receive requests from user-operated client devices 108a-108e. Server 104 and client devices 108a-108e may be communicatively coupled through a network 106. In some implementations, client devices 108a-108e may request data from server 104. Upon receiving the request, server 104 may retrieve a set of data from database 102 and serve the set of information to client devices 108a-108e.

Each of client devices 108a-108e can represent various forms of processing devices. Example processing devices can include a desktop computer, a laptop computer, a handheld computer, a television with one or more processors attached or coupled thereto, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices.

In some aspects, client devices 108a-108e may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108a-108e) can communicate with servers 104 via a virtual private network (VPN), Secure Shell (SSH) tunnel, or other secure network connection. In some aspects, network 106 may further include a corporate network (e.g., intranet) and one or more wireless access points.

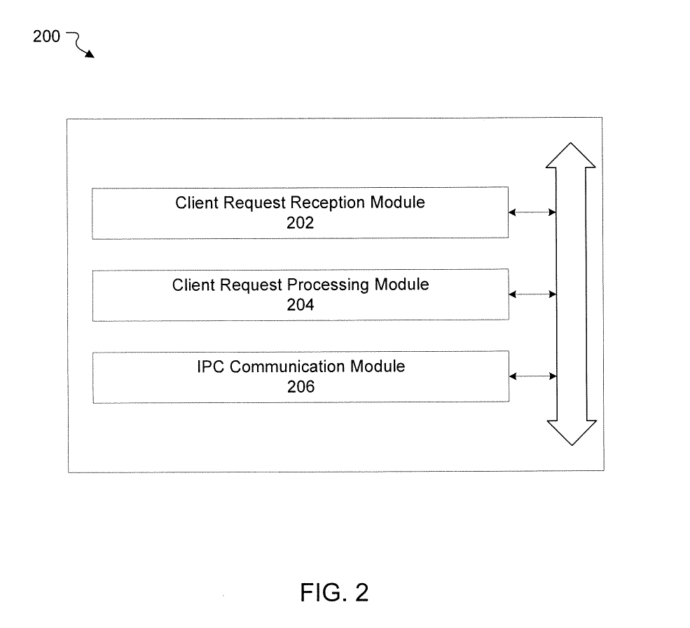

FIG. 2 illustrates an example of a system for accessing a camera across multiple processes operating on a client device. System 200 includes client request reception module 202, client request processing module 204, and an inter-process communication (IPC) communication module 206. These modules, which are in communication with one another, receive a client request and process the request in order to control a camera device. For example, client requests may be received by client request reception module 202. Once received, the client request is processed by client request processing module 204. Client request processing module 204 may determine camera capture parameters such as resolution or frame rate based on the received client request. IPC communication module 206 may then send control data to a device controller. For example, IPC communication module 206 may send a request that include data such as a desired resolution or aspect ratio so that a proper video feed may be provided by the camera device.

In some aspects, the modules may be implemented in software (e.g., subroutines and code). The software implementation of the modules may operate on applications running on client devices 108a-108e. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

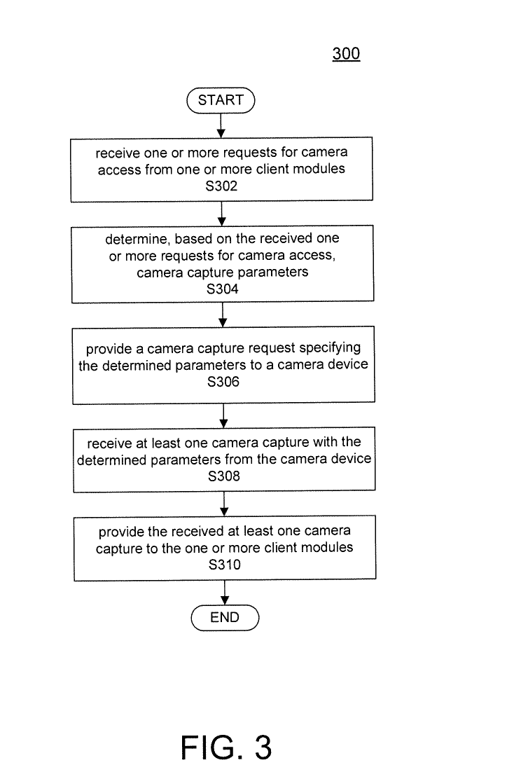

FIG. 3 illustrates example method 300 for accessing a camera across multiple processes operating on a client device. One or more requests for camera access is received from one or more client modules in S302. Camera access may include, but is not limited to, operations such as enumerate devices, open/close a device, start/stop capture, etc. Camera capture parameters are determined based on the received one or more requests for camera access. A camera capture request specifying the determined parameters is provided to a camera device in S306. At least one camera capture with the determined parameters from the camera device is received in S308, in response to the camera capture request. The received at least one camera capture is then provided to the one or more client modules in S310.

In some implementations, requests for camera access may be received from one or more client modules of a client processes (e.g., web browser application, video chat application, video editing application, etc.). For example, an application may include multiple client modules that request camera access simultaneously. The requests may be gathered by a relay agent and a single IPC representing the multiple client modules of the same client process is passed onto a device controller of a service process including a camera device.

The relay agent may determine camera capture parameters based on the requests for camera access received from the client modules in some implementations. For example, the camera capture parameters may be determined based on multiple camera access requests with two or more different video resolutions (e.g., high definition format, common intermediate format, etc.). In some aspects, the camera capture parameters may be determined to correspond to the highest resolution requested. The camera capture parameters may further be determined to correspond to the highest resolution and/or frame rate. When the camera capture parameters correspond to the highest resolution or frame rate requested, the camera capture returned from the service process may be downsampled to provide for the requests for a lower resolution video. Downsampling a higher resolution video to fulfill camera access requests minimizes the degradation of the video quality provided.

In some implementations, the camera device may not have the capability to produce a camera capture with the exact parameters specified in the request. Instead, the camera device may produce a camera capture with parameters most closely related to the specified parameters. For example, a camera capture at a resolution of 720p may be requested; however, the highest resolution, and thus the most closely related resolution, the camera device is capable of recording may only be 480p. Accordingly, the camera device may produce the camera capture at a resolution of 480p. The camera capture is then provided to the one or more client modules. In some aspects, the received camera capture may be upsampled from the lower resolution capture before being provided to the one or more client modules to fulfill the camera access request.

In some implementations, a request for two sets of frames of the camera capture representing two different resolutions may be communicated to the device controller. For example, if requests from a first set of client modules requesting a first resolution and requests from a second set of client modules requesting a second resolution are received, then one set of frames for each resolution may be provided to the respective set of client modules. While providing a set of frames for each of the two resolutions initially requires additional processing, doing so eliminates the need for each of the set of client modules that did not receive content in the requested resolution to individually downsample (or upsample in some cases) the camera capture, thereby reducing the net amount of processing required in order to provide the video capture to all client modules.

In some implementations, a client module may be designated as a master client module. When a request for camera access is received from the master client module, the relay agent passes onto the device controller a single IPC to initiate a camera capture based on the camera capture parameters requested by the master client. In a case where two or more requests with different camera capture parameters are received by the relay agent, the camera capture parameters of the master client module is passed onto the device controller by the relay agent regardless of camera capture parameters received from client modules. For example, if a master client module requests a lower resolution video than that of another client module, the relay agent requests a camera capture initiated in lower resolution. The request for the other client module may be fulfilled by upsampling the camera capture even though a degradation in video quality may result.

In some implementations, a first request for camera access and a second request for camera access may be received by the relay agent at different times. When the second request is received after a camera capture has been initiated based on the first request, a determination of whether a change in camera capture parameters is necessary is made. If a change in the camera capture parameters is necessary, the relay agent sends a command to restart the camera capture based on the new camera capture parameters. If a change is not necessary, the camera capture continues using the current camera capture parameters. The determination of whether a change in camera capture parameters is necessary may be made based on several factors. For example, a second request may require a higher resolution than the first request. Alternatively, the second request may be received from a master client module. In both instances, camera capture parameters may be changed to capture video at a resolution corresponding to the second request. In order to initiate the change, the relay agent may instruct the device controller to restart the camera capture with camera capture parameters corresponding to the second request.

In some aspects, a stop request may be received by the relay agent from one of several client modules that have requested access to the camera device. When a stop request is received, the relay agent may deregister the client module without changing the aspect ratio of the camera capture requested. Alternatively, the relay agent may determine new camera capture parameters based on the remaining client modules accessing the camera device. For example, the new camera capture parameters may correspond to the highest resolution requested by the remaining client modules. If, however, a master client module exists, the camera capture parameters may remain unchanged. To initiate a change, the relay agent may instruct the device controller to restart the camera capture with the new camera capture parameters, thereby saving some computing resources (e.g., CPU cycles, memory bandwidth, etc.).

The camera capture parameters may include an aspect ratio in some implementations. Camera captures received by the relay agent in response to a camera capture request may be cropped or padded in order to fit the aspect ratios requested by different client modules. For example, if a client module requests a camera capture with an aspect ratio that is different from the aspect ratio of the initiated camera capture, the relay agent may crop the camera capture by omitting certain pixels of the camera capture in order to properly fit into the aspect ratio required by the client module. Alternatively, the relay agent may pad the camera capture by adding additional pixels to the camera capture in order to properly fit into the aspect ratio required by the client module. By cropping and padding, camera captures of one aspect ratio may be modified to fit in a variety of aspect ratios requested by the client modules. Camera captures may further be downsampled or upsampled to correspond to the resolution required by the different client modules. Downsampling is performed when the resolution of the camera capture is higher than the resolution required by a client module. Conversely, upsampling is performed when the resolution of the camera capture is lower than the resolution required by a client module.

In some implementations, the relay agent may determine the aspect ratio based on a highest frame width and a highest frame height extracted from the requests received from the client modules. The dimension corresponding to the highest frame width and the highest frame height may be rounded up to the next lowest resolution supported by a corresponding camera device. For example, a resolution for which the number of pixels is the lowest (i.e., the smallest width by height dimension) may be used. If no resolution is found by rounding up, the dimensions corresponding to the highest frame width and the highest frame heights may alternatively be rounded down to the next highest resolution supported by the corresponding camera device. In this example, a resolution for which the sum of the number of pixels requested by the client module but not captured by the camera capture is the smallest may be used. A camera capture with the specified resolution may then be provided to the client modules. The camera captures may then be cropped or padded in order to fit the aspect ratios requested by different client modules.

In some implementations, the relay agent may utilize bitstream compression in order to transfer high resolution camera captures across certain connectors effectively and efficiently. For example, a connection, such as one established with a universal serial bus (USB), may have limited amount of bandwidth. By compressing the high resolution camera capture, the latency associated with a transfer of the camera capture may be minimized or eliminated. When no bandwidth issues exists, however, the camera capture may be transferred as an uncompressed full frame video.

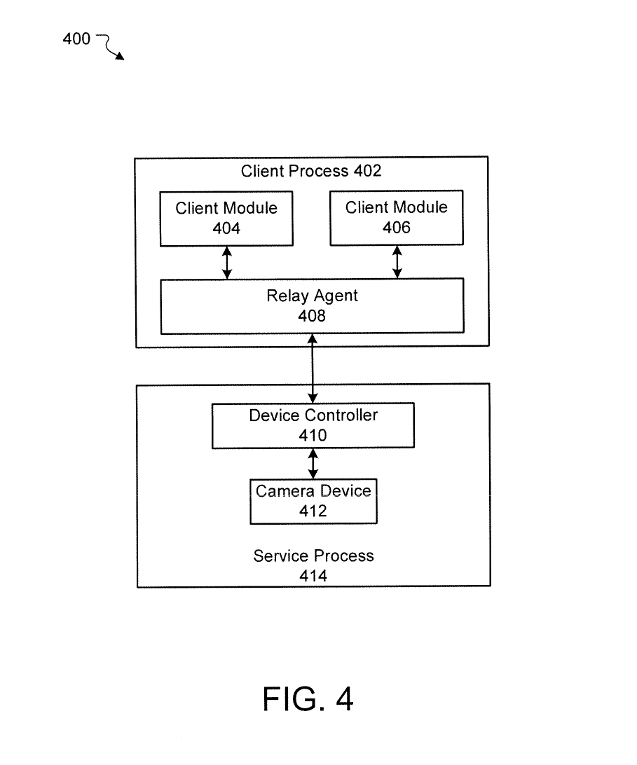

FIG. 4 provides an example graphical representation of accessing a camera across multiple processes operating on a client device. Client process 402 comprises two client modules 404 and 406 that may request access to camera device 412. In FIG. 4, Relay agent 408 may gather all requests from client modules 404 and 406. Relay agent 408 may create an aggregate request, based on the gathered requests, to pass onto device controller 410 in service process 414. The gathered requests may be passed onto device controller 410 via IPC. Control data and camera capture data are passed back and forth between relay agent 408 and device controller 410 so that client modules 404 and 406 can seamlessly access camera device 412 without knowing the existence of IPC. In other words, relay agent 408 serves as an intermediary between client modules 404 and 406 by representing a camera device application programming interface to client modules 404 and 406. Typically, only one IPC may be received per relay agent. Each relay agent may also represent a camera device application programming interface to the client modules in order to reduce communication overhead.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

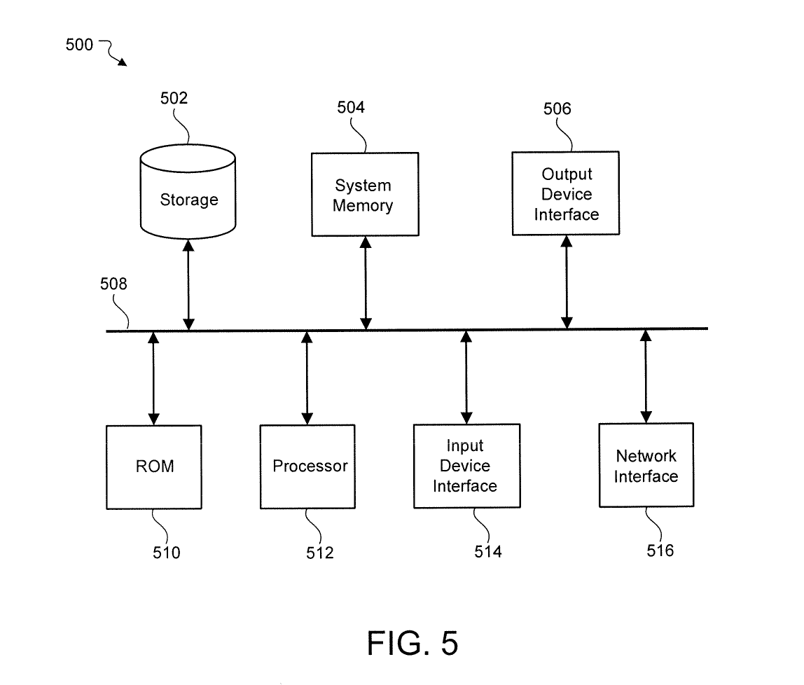

FIG. 5 conceptually illustrates an example electronic system 500 with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for sharing a camera device between multiple processes operating on a client device in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interface 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers, such as a local area network, a wide area network, or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network and a wide area network, an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method of accessing a camera across processes on a device, the method comprising:
receiving one or more requests for camera access from a corresponding one or more client modules;
determining, based on the received one or more requests for camera access, camera capture parameters;
providing a camera capture request specifying the determined parameters to a camera device;
receiving, from the camera device, at least one camera capture with the determined parameters; and
providing the received at least one camera capture to the one or more client modules.

2. The computer-implemented method of claim 1, wherein the camera capture parameters are determined based on at least one of a resolution, an aspect ratio, or a frame rate indicated in the requests from the one or more client modules.

3. The computer-implemented method of claim 2, wherein the camera capture parameters comprise a resolution corresponding to the highest resolution received in the one or more requests from the one or more client modules.

4. The computer-implemented method of claim 2, wherein the camera capture parameters comprise an aspect ratio, the aspect ratio being determined based on a highest frame width and a highest frame height extracted from the one or more requests for camera access.

5. The computer-implemented method of claim 2, wherein the camera capture parameters comprise a frame rate corresponding to the highest frame rate received in the one or more requests from the one or more client modules.

6. The computer-implemented method of claim 2, wherein the camera capture parameters comprise parameters corresponding to at least one of a median resolution, a median aspect ratio, or a median frame rate of the received one or more requests from the one or more client modules.

7. The computer-implemented method of claim 1, further comprising identifying one of the one or more client modules as a master client module, wherein the camera capture parameters are determined based the request received from the identified master client module.

8. The computer-implemented method of claim 1, wherein receiving the one or more requests for camera access from the corresponding one or more client modules comprises receiving a first set of requests requiring a first resolution and receiving a second set of requests requiring a second different resolution, and wherein the at least one camera capture with the determined parameters is a first camera capture with a first set of determined parameters corresponding to the first resolution, the method further comprising receiving, from the camera device, a second camera capture with a second set of determined parameters corresponding to the second resolution.

9. The computer-implemented method of claim 8, wherein providing the received at least one camera capture to the one or more client modules comprises providing the first camera capture to client modules corresponding to the first set of requests and providing the second camera capture to client modules corresponding to the second set of requests.

10. The computer-implemented method of claim 1, wherein providing the received at least one camera capture to the one or more client modules comprises downsampling the received at least one camera capture when a resolution of the received at least one camera capture is higher than a resolution requested by a client module, and upsampling the received at least one camera capture when a resolution of the received at least one camera capture is lower than a resolution requested by a client module.

11. The computer-implemented method of claim 1, wherein providing the received at least one camera capture to the one or more client modules comprises at least one of cropping or padding the received at least one camera capture when an aspect ratio of the received at least one camera capture is different from an aspect ratio requested by a client module.

12. A machine-readable medium comprising instructions stored therein, which when executed by a system, cause the system to perform operations comprising:
receiving a plurality of requests for camera access from a corresponding plurality of client modules;
determining a resolution for at least one camera capture based on the received one or more requests for camera access;
providing a camera capture request specifying the determined resolution to a camera device;
receiving, from the camera device, at least one camera capture based on the specified determined resolution;
providing the at least one camera capture to each of the plurality of client modules.

13. The machine-readable medium of claim 12, further comprising instructions for resampling the received at least one camera capture to correspond to each of the plurality of requests received from the corresponding plurality of client modules, wherein providing the at least one camera capture to each of the plurality of client modules provides the resampled at least one camera capture to each of the plurality of client modules.

14. The machine-readable medium of claim 12, wherein the resolution for the at least one camera capture is determined based on a highest resolution requested in the received one or more requests for camera access.

15. The machine-readable medium of claim 12, wherein a resolution of the received at least one camera capture is different from the determined resolution for the at least one camera capture.

16. The machine-readable medium of claim 12, further comprising instructions for determining an aspect ratio for the at least one camera capture based on the received one or more requests for camera access, wherein providing the camera capture request further comprises specifying the determined aspect ratio to the camera device.

17. The machine-readable medium of claim 16, wherein the aspect ratio for the at least one camera capture is determined based on a highest frame width and a highest frame height extracted from the one or more requests for camera access.

18. The machine-readable medium of claim 12, further comprising instructions for determining a frame rate for the at least one camera capture based on the received one or more requests for camera access, wherein providing the camera capture request further comprises specifying the determined frame rate to the camera device.

19. The machine-readable medium of claim 18, wherein the frame rate for the at least one camera capture is determined based on a highest frame rate requested in the received one or more requests for camera access.

20. The machine-readable medium of claim 12, further comprising instructions for identifying one of the plurality of client modules as a master client module, wherein the resolution for the at least one camera capture is determined based the request received from the master client module.

21. A system for accessing a camera across processes on a device, the system comprising:
one or more processors; and
a machine-readable medium comprising instructions stored therein, which when executed by the processors, cause the processors to perform operations comprising:
receiving one or more requests for camera access from a corresponding one or more client modules;
determining, based on the received one or more requests for camera access, camera capture parameters;
providing a camera capture request specifying the determined parameters to a camera device;
receiving, from the camera device, at least one camera capture with the determined parameters;
resizing the received at least one camera capture to correspond to each of the plurality of requests received from the corresponding plurality of client modules; and
providing the resized at least one camera capture to the one or more client modules.

22. The system of claim 21, wherein resizing the received at least one camera capture comprises at least one of cropping or padding the at least one camera capture when an aspect ratio of the received at least one camera capture is different from an aspect ratio requested by a client module.
